(19) United States
(12) Patent Application Publication
(10) Pub. No.: US 2026/0264430 A1
(43) Pub. Date: Sep. 10, 2026

(54) LOTTERY TICKET SELLING SYSTEM HAVING A LOTTERY TICKET PRINTER, A LOTTERY TICKET REWINDER, AND A PRINTER AND REWINDER CRADLE

(71) Applicant: Brightstar Global Solutions Corporation, Providence, RI (US)

(72) Inventor: Robert Corvese, Warwick, RI (US)

(21) Appl. No.: 19/071,381

(22) Filed: Mar. 5, 2025

(51) Int. Cl. B41J 29/06; A63F 3/06; B41J 3/30; B41J 15/04; B41J 15/16; G07C 15/00; G07F 17/42

(52) U.S. Cl. CPC B41J 29/06; A63F 3/0655; B41J 3/30; B41J 15/04; B41J 15/16; G07C 15/005; G07F 17/42

(57) ABSTRACT

Lottery ticket selling systems and methods of operating the systems that enable the purchases of draw lottery tickets and include an electronic ticket courier server, a wager details display device, a lottery terminal, a lottery ticket printer, a draw lottery ticket printer, a draw lottery ticket rewinder, and a printer and rewinder cradle comprising a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support.

### BACKGROUND

The present disclosure relates to a lottery ticket selling system having a lottery ticket printer, a lottery ticket rewinder, and a printer and rewinder cradle.

For a draw lottery ticket for a draw lottery game, a player may select the player numbers or may have an electronic lottery system randomly select the player numbers (which is often referred to as a quick pick). Draw lottery tickets may be purchased in variety of different manners using a variety of different systems such as systems that include lottery terminals. Various different jurisdictions (such as states) have different rules regarding how such draw lottery tickets can be purchased.

### BRIEF SUMMARY

In various embodiments, the present disclosure relates to a lottery ticket selling system including: an electronic ticket courier server; a wager details display device; a lottery terminal; a lottery ticket printer; a draw lottery ticket printer; a draw lottery ticket rewinder; and a printer and rewinder cradle. The printer and rewinder cradle includes a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support.

In various other embodiments, the present disclosure relates to a lottery ticket selling system including: an electronic ticket courier server; a wager details display device; a lottery terminal; a lottery ticket printer; a draw lottery ticket printer; a draw lottery ticket rewinder; and a printer and rewinder cradle. The printer and rewinder cradle includes a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support. The static distance enables the draw lottery ticket rewinder to apply a predetermined amount of tension to a continuous sheet of connected draw lottery tickets printed by the draw lottery ticket printer. The rewinder holder is also positioned to hold the draw lottery ticket rewinder such that the draw lottery ticket rewinder can rotatably support a removable storage spool in alignment with a continuous sheet of connected draw lottery tickets printed by the draw lottery ticket printer.

In various other embodiments, the present disclosure relates to a lottery ticket selling system including: an electronic ticket courier server; a wager details display device; a lottery terminal; a lottery ticket printer; a draw lottery ticket printer; a draw lottery ticket rewinder; printer and rewinder cradle, and a sensor. The printer and rewinder cradle includes a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support. The static distance enables the draw lottery ticket rewinder to apply a predetermined amount of tension to a continuous sheet of connected draw lottery tickets printed by the draw lottery ticket printer. The rewinder holder is also positioned to hold the draw lottery ticket rewinder such that the draw lottery ticket rewinder can rotatably support a removable storage spool in alignment with a continuous sheet of connected draw lottery tickets printed by the draw lottery ticket printer. The sensor enables control of when the draw lottery ticket rewinder rewinds the continuous sheet of connected draw lottery tickets printed by the draw lottery ticket onto the storage spool.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket.

FIG. 2 is a diagrammatic view of a known lottery ticket selling system.

FIG. 3 is a diagrammatic perspective view of an example lottery ticket selling system including, among other components, a draw lottery ticket printer, a draw lottery ticket rewinder, and a printer and rewinder cradle in accordance with one example embodiment of the present disclosure.

FIG. 4 is an enlarged top perspective view of the draw lottery ticket printer, the draw lottery ticket rewinder, and the printer and rewinder cradle of FIG. 3.

FIG. 5 is an enlarged side view of the draw lottery ticket printer, the draw lottery ticket rewinder, and the printer and rewinder cradle of FIG. 3.

FIG. 6 is an enlarged top view of the draw lottery ticket printer, the draw lottery ticket rewinder, and the printer and rewinder cradle of FIG. 3.

FIG. 7 is an enlarged top perspective view of the printer and rewinder cradle of FIG. 3.

FIG. 8 is an enlarged bottom perspective view of the draw lottery ticket printer and the draw lottery ticket rewinder of FIG. 3, before the lottery ticket printer and the lottery ticket rewinder are positioned in the printer and rewinder cradle of FIG. 3.

FIG. 9 is an enlarged top perspective view of a printer and rewinder cradle of an alternative embodiment of the present disclosure.

FIG. 10 is an enlarged top perspective view of a printer and rewinder cradle of another alternative embodiment of the present disclosure.

### DETAILED DESCRIPTION

In various embodiments, the present disclosure relates to a lottery ticket selling system that includes, among other components, a draw lottery ticket printer, a draw lottery ticket rewinder, and a printer and rewinder cradle. The draw lottery ticket printer, the draw lottery ticket rewinder, and the printer and rewinder cradle precisely control the printing and movements of the connected printed draw lottery tickets, and the winding of the connected printed draw lottery tickets for storage and subsequent use.

For brevity, the draw lottery ticket printer is sometimes referred to as the “printer” herein, the draw lottery ticket rewinder is sometimes referred to as the “rewinder” herein, and the printer and rewinder cradle is sometimes referred to as the “cradle” herein.

Draw lottery tickets for draw lottery games are employed as example lottery tickets herein; however, it should be appreciated that the present disclosure is not meant to be limited by such examples.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for selling various other draw lottery tickets.

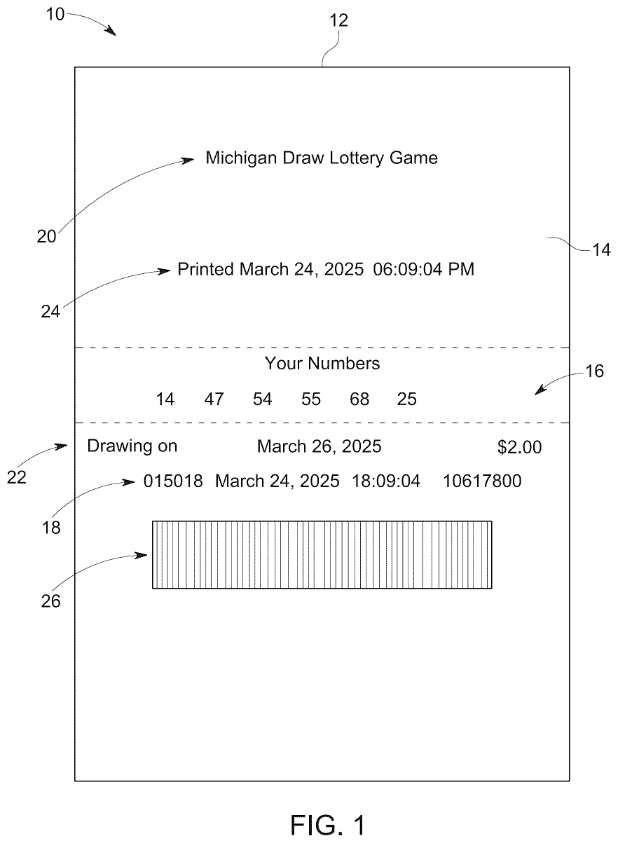

An example physical draw lottery ticket 10 is shown in FIG. 1. This example draw lottery ticket includes: (1) a ticket substrate 12; (2) a front surface 14 of the ticket substrate 12; (3) draw lottery ticket information, including a single set of player numbers (for a single play of draw lottery game), printed on the front surface 14 of the ticket substrate 12; and (4) a back surface (not shown) of the ticket substrate 12. This example draw lottery ticket 10 is for a single play of a draw lottery game (scheduled to take place on Mar. 26, 2025) and includes a single set of player numbers 16 (i.e., player numbers for the single play of the draw lottery game). The draw lottery ticket information in this example includes player numbers 16, a draw lottery ticket identifier 18 that uniquely identifies the draw lottery ticket 10, a game identifier 20 that identifies the draw lottery game, a draw date 22 associated with the draw lottery ticket 10, and a print date 24 on which the draw lottery ticket 10 was printed. The draw lottery ticket information can include text, a draw lottery ticket number such as the draw lottery ticket identifier 18, a draw lottery ticket barcode such as barcode 26, and/or other draw lottery ticket information that is in either or both human readable and machine-readable forms. The draw lottery ticket's barcode 26 is configured to be scanned by a barcode reading device to enable redemption of the draw lottery ticket.

Additionally, for a better understanding of the present disclosure, an example known system and method employed for selling draw lottery tickets is also now described.

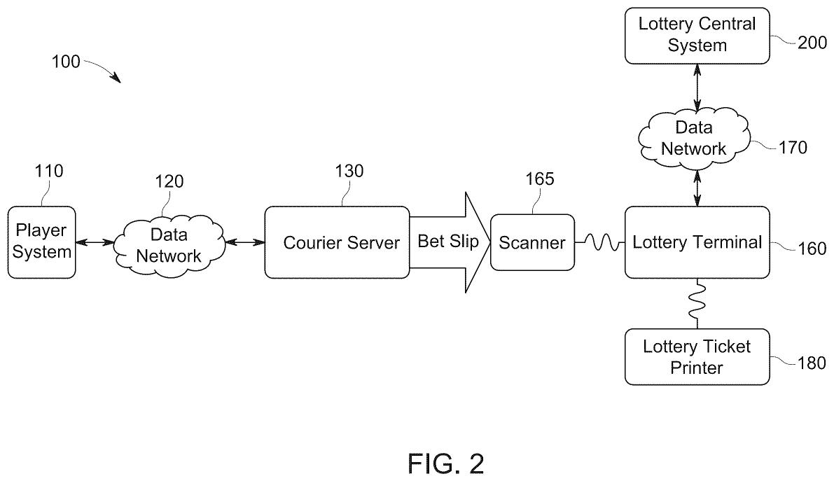

In various jurisdictions (such as states) that do not permit the remote electronic purchase of draw lottery tickets (such as via a website), a draw lottery ticket system 100 using a courier service has been employed. Turning to FIG. 2, the draw lottery ticket system 100 includes: (a) an electronic player system 110 with a courier mobile application downloaded thereon; (b) a courier server 130; (c) a lottery terminal 160; (d) a scanner 165 that is part of or that is associated with the lottery terminal 160; (e) a draw lottery ticket printer 180; and (f) a central lottery system 200. The electronic player system 110 and the courier server 130 are configured to communicate via a suitable data network 120. The lottery terminal 160 and the scanner 165 are configured to communicate via hard wire such as an USB connector. The lottery terminal 160 and the draw lottery ticket printer 180 are configured to communicate via hard wire such as an USB connector. The lottery terminal 160 and the lottery central system 200 are configured to communicate via a data network 170.

The electronic player system 110 includes an electronic player device such as a smartphone with the courier mobile application downloaded thereon. The courier server 130 includes a server configured to receive draw lottery game bet details from the electronic player system 110 via the courier mobile application and to generate a suitable bet for a play of the draw lottery game based on the draw lottery game bet details. The bet includes the player numbers for a selected play of a selected draw lottery game. The courier server 130 causes a bet slip to be printed such that the bet slip can be scanned by the scanner 165. A human courier processing clerk takes the physical printed paper bet slip for the play of the draw lottery game to the lottery terminal 160 to scan the physical printed paper bet slip. The scanner 165 scans the bet slip and the lottery terminal 160 uses that bet slip scan data to determine the player numbers for the play of the draw lottery game and to create the draw lottery ticket for the player. The lottery terminal 160 causes the draw lottery ticket printer 180 to print out the draw lottery ticket with the player numbers. The operator of the lottery terminal 160 also collects the payment for the draw lottery ticket from the courier processing clerk and provides the printed draw lottery ticket to the courier processing clerk. The courier processing clerk takes the physical printed bet slip and the physical printed draw lottery ticket back to the courier processing center. The courier processing clerk scans the physical printed draw lottery ticket using a courier scanning system (not shown) connected to the courier server 130. The courier server 130 links the scanned draw lottery ticket back to a player account established through the courier mobile application. The courier server 130 then makes the scanned draw lottery ticket available for the player to view via the courier mobile application on the electronic player system 110. The courier processing clerk places the physical printed bet slip and the physical printed draw lottery ticket in secure courier storage locations for storage if needed at a later time.

After the draw for the play of the draw lottery game takes place, if the player's draw lottery ticket is a winning draw lottery ticket and the winning amount is less than $600, the courier server automatically credits the winning amount for the player's draw lottery ticket to the player's account. The courier service can then retrieve and redeem the stored actual winning physical printed draw lottery ticket at a location having a lottery terminal. After the draw for the draw lottery game takes place, if the player's draw lottery ticket is a winning draw lottery ticket and the winning amount is $600 or more, a courier processing clerk retrieves the stored winning physical player draw lottery ticket from the courier storage location and provides that physical printed draw lottery ticket to the player so that the player can redeem that draw lottery ticket and obtain the winning amount.

The present disclosure is configured to be employed with various improvements to the courier system described above.

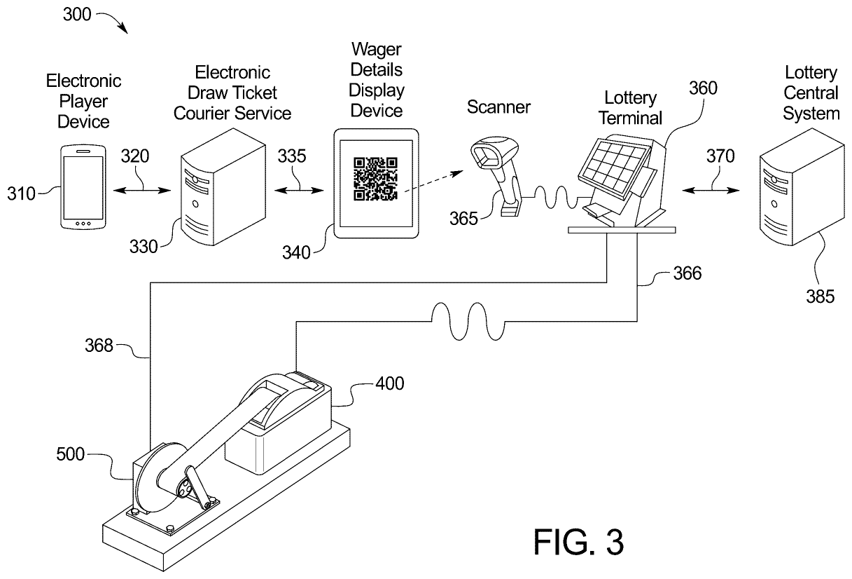

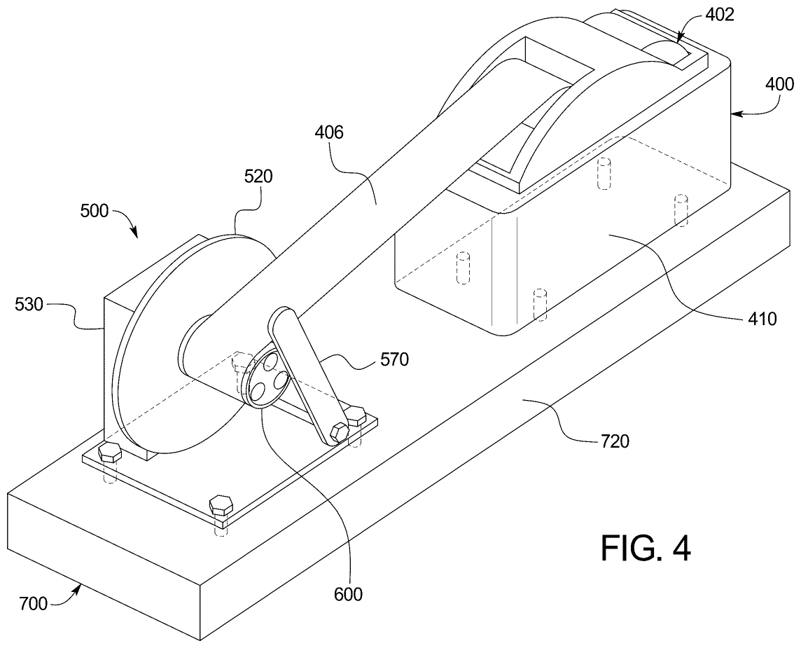

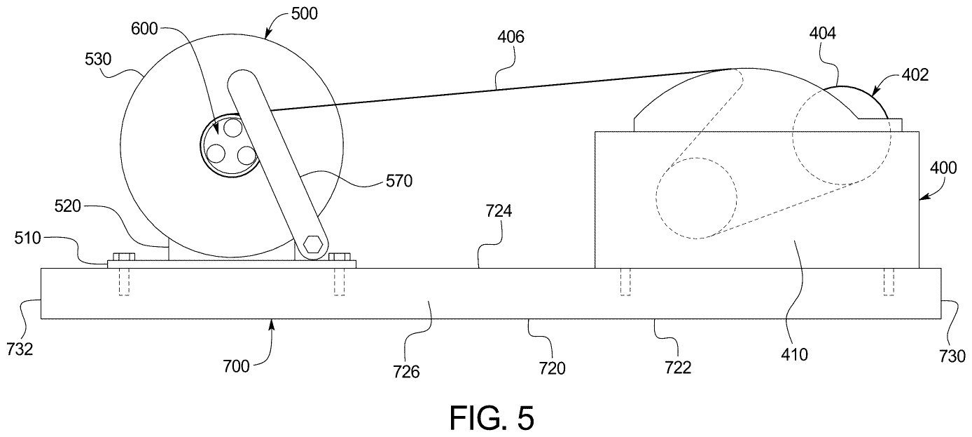

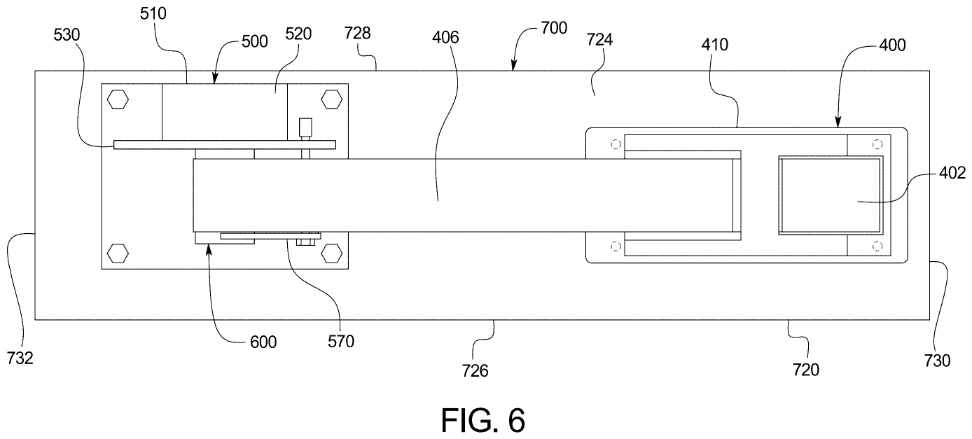

Turning now to FIGS. 3 to 8, an example lottery ticket selling system 300 in accordance with one example embodiment of the present disclosure is generally shown.

This illustrated example lottery ticket selling system 300 includes: (a) a player electronic device 310 with a courier mobile application downloaded thereon; (b) an electronic ticket courier server 330; (c) a wager details display device 340; (d) a lottery terminal 360; (e) a draw lottery ticket printer 400; (f) a lottery central system 385; (g) a draw lottery ticket rewinder 500; and (h) a printer and rewinder cradle 700.

In this illustrated example embodiment, the electronic player device 310 and the courier server 330 are configured to communicate with each other via a suitable data network 320.

In this illustrated example embodiment, the courier server 330 and the wager details display device 340 are configured to communicate with each other via a hard wire connection such as a USB connector 335. In other embodiments, the communication between these components can be via wireless connection such as Bluetooth, or other suitable data connection such as via a suitable data network (such as but not limited to a cellular data network or the Internet).

In this illustrated example embodiment, the lottery terminal 360 and the draw lottery ticket printer 400 are configured to communicate with each other via hard wire 366. In other embodiments, the communication between these components can be via a suitable data network.

In this illustrated example embodiment, the lottery terminal 360 and the draw lottery ticket printer 400 are configured to communicate with each other via hard wire 366. In other embodiments, the communication between these components can be via a suitable data network.

In this illustrated example embodiment, the lottery terminal 360 and the draw lottery ticket rewinder 500 are configured to communicate with each other via hard wire 368. In other embodiments, the communication between these components can be via a suitable data network.

In this illustrated example embodiment, the lottery terminal 360 and the lottery central system 385 are configured to communicate with each other via a suitable data network 370 such as a secure data network.

Generally, the lottery ticket selling system 300: (1) enables a purchaser to employ the electronic player device 310 to order and purchase a draw lottery ticket for a play of a draw lottery game; (2) causes the electronic player device 310 to send an order including the wager details for the purchase of the draw lottery ticket to the courier server 330; (3) causes the courier server 330 to generate a wager details code (such as a QR code) based on the wager details for the ordered draw lottery ticket to be purchased; (4) causes the courier server 330 to cause the wager details display device 340 to display the code to enable scanning of the code by the scanner 365 of the lottery terminal 360 to enable the lottery terminal 360 to obtain the wager details for the ordered draw lottery ticket to be purchased; (5) causes generation of the draw lottery ticket based on the wager details; (6) generates and sends the draw lottery ticket data to the lottery central system 385; (7) causes the draw lottery ticket printer 400 to print the purchased draw lottery ticket T on a section of paper from a supply spool 402 of lottery ticket printer paper supported by the draw lottery ticket printer 400; and (8) causes the draw lottery ticket rewinder 500 to wind the printed draw lottery ticket on a removable storage spool 600 supported by the rewinder 500.

The printer 400 does not separate each of the draw lottery tickets printed on the lottery ticket printer paper but rather maintains each sequentially printed draw lottery ticket connected together on the single elongated sheet of paper 406 that is rolled onto a storage spool 600 by the rewinder 500 for storage and potential later access. In other words, the lottery ticket rewinder 500 is configured to receive the connected printed draw lottery tickets 406 from the lottery ticket printer 400 and wind the connected printed draw lottery tickets 406 on the storage spool 600 for storage.

The present disclosure addresses the specific issue of ensuring that the elongated sheet of draw lottery tickets 406 that includes each connected printed draw lottery ticket is properly wound on the storage spool 600.

More specifically, the draw lottery ticket printer 400 includes: (a) a printer housing 410; (b) a supply paper roll holder (not shown) supported by the housing 410 and configured to receive and rotatably hold a supply paper roll 402; (c) a plurality of paper engagers (not shown) supported by the printer housing 410 and that guide and control the movement of the paper through and out of the printer 400; and (d) a controller (not shown) supported by the housing 410 and that controls the printing of the draw lottery tickets on the paper 406. The size, shape, and configuration of the draw lottery ticket printer 400 can vary in accordance with the present disclosure. The example lottery ticket printer 400 is configured to receive draw lottery ticket print data from the lottery terminal 360 for each draw lottery ticket and process the draw lottery ticket print data via the controller to advance the supply paper from the supply paper roll 402 through a printing path and print the draw lottery tickets 406. The supply paper roll holder 412 includes a spindle (not shown), a curved recess for the supply paper roll 402, and/or other suitable holders for supporting the supply paper roll 402. The roll engagers of the draw lottery ticket printer 400 can include one or more driven spindles, guide spindles, driven rollers, guide rollers, or other suitable components. In various other embodiments, the lottery ticket printer 400 can include multiple supply paper roll holders that support multiple supply paper rolls).

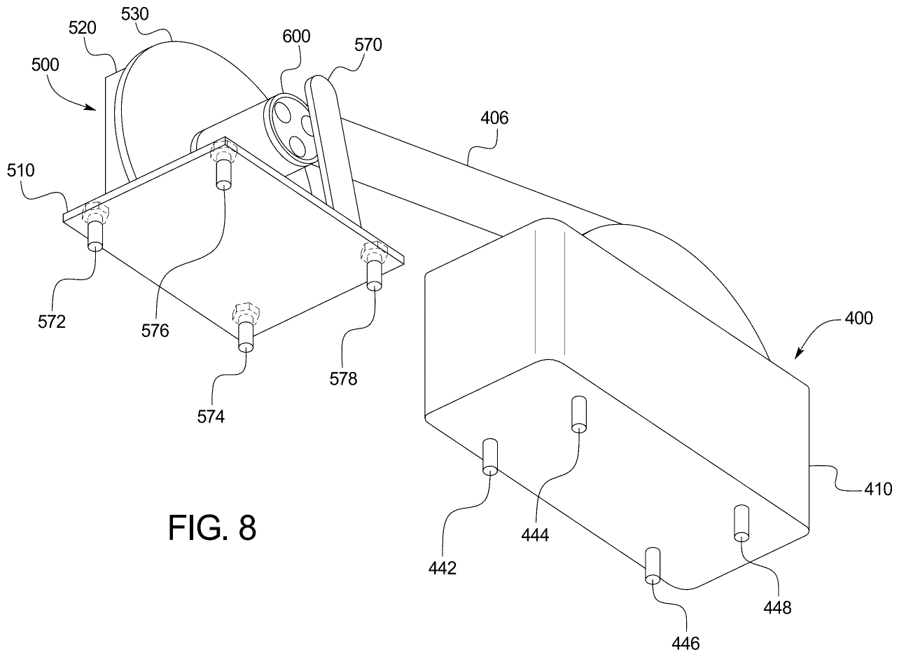

The draw lottery ticket printer 400 also includes four spaced-apart feet 442, 444, 446, and 448 extending downwardly from the housing 410 as best shown in FIG. 8.

The supply paper roll 402 can be any suitable roll of lottery ticket paper on which draw lottery tickets can be printed by the draw lottery ticket printer 400. In various embodiments, the supply paper roll 402 includes one or more security features, such as a watermark feature or other suitable security feature.

After printing of draw lottery tickets onto the paper from the supply paper roll 402, the connected draw lottery tickets 406 are sequentially fed to the rewinder 500 where they are wound around a storage spool 600.

The draw lottery ticket rewinder 500 includes; (1) a base 510; (2) a support 520 connected to and extending upwardly from the base 510; (3) an electric drive motor (not shown) supported by the support 520; (4) a rotatable spool holder 530 connected to and supported by the drive motor; (5) one or more paper guide assemblies such as paper guide assembly 570 supported by the base 510 and configured to guide the paper 406 onto the spool 600; and (6) a controller (not shown) configured to receive signals from the lottery terminal 360 and/or printer 400 and to control the electric drive motor. The controller can include a processor. The spool holder 530 is configured to support a removable storage spool such as spool 600. The base 510 defines four spaced-apart fastener openings though which fasteners such as example fasteners 572, 574, 576, and 578 can extend to suitably attach the rewinder 500 to the cradle 700.

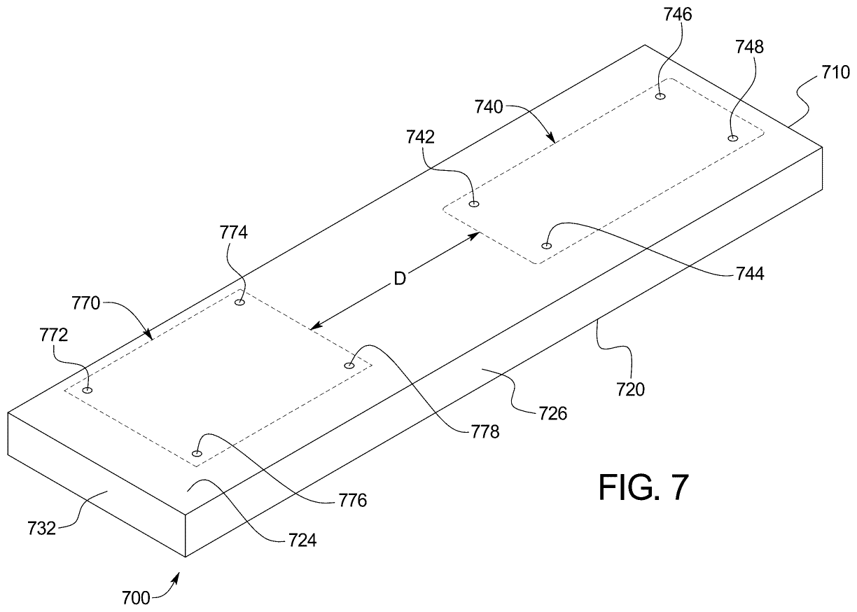

The printer and rewinder cradle 700 of this example embodiment of the present disclosure includes: (a) a support 720; (b) a printer holder 740; (c) a rewinder holder 770 as best indicated in FIG. 7.

In this example embodiment, the longitudinal length of the support 720 of the cradle 700 is pre-set and the distance between the printer holder 740 and the rewinder holder 770 is a predetermined distance D to precisely position the printer 400 and the rewinder 500 relative to each other on the support 720. This pre-set precise distance D enables the tension(s) applied to the paper and speed of the rewinder 500 to be pre-set based in part on that predetermined distance D.

The support 720 provides a support member for the printer 400 and for the rewinder 500. In this example, the support 720 includes: (1) a bottom surface 722; (2) a top surface 724 spaced-apart from the bottom surface 722; (3) a first side surface 726; (4) a second side surface 728 spaced-apart from the first side surface 726; (5) a first end surface 730; and (6) a second end surface 732 spaced-apart from the first end surface 730. In this example embodiment, the support 720 is generally rectangular, but can be another suitable shape.

The printer holder 740 includes one or more and in this example embodiment four printer feet receipt slots 742, 744, 746, and 748 that each extend downwardly from the top surface 724 of the support 720 into the support 720 a preset distance (equal to or otherwise corresponding to the height of the feet 442, 444, 446, and 448 extending downwardly from the bottom of the housing 410 of the printer 400). The four printer feet receipt slots 742, 744, 746, and 748 are aligned, positioned, sized, shaped, and otherwise configured to respectively receive the four downwardly extending feet 442, 444, 446, and 448 of the printer 400. In this example embodiment, (1) the printer feet receipt slots 742 and 744 are longitudinally aligned; (2) the printer feet receipt slots 746 and 748 are longitudinally aligned; (3) the printer feet receipt slots 742 and 746 are transversely aligned; and (4) the printer feet receipt slots 744 and 748 are transversely aligned. When the printer 400 is positioned on the support 720 with its feet 442, 444, 446, and 448 in the respective four printer feet receipt slots 742, 744, 746, and 748, the support 720 securely holds the printer 400 and prevents both longitudinal and transverse movement of the printer 400 relative to the support 720 and to the rewinder 500 (that could occur, for instance, due to vibrations from the printing of the tickets by the printer 400).

The rewinder holder 770 includes one or more and in this example embodiment four rewinder fastener receipt slots 772, 774, 776, and 778 that each extend downwardly from the top surface 724 of the support 720 and that are aligned, positioned, sized, shaped, and otherwise configured to respectively receive four downwardly extending fasteners (such as bolts 572, 574, 576, and 578) that attach the rewinder 500 to the support 720. In this example embodiment, (1) fastener receipt slots 772 and 774 are longitudinally aligned; (2) fastener receipt slots 776 and 778 are longitudinally aligned; (3) fastener receipt slots 772 and 776 are transversely aligned; and (4) fastener receipt slots 774 and 778 are transversely aligned. In this example, since the fasteners are threaded bolts, the rewinder holder 770 can include interior threaded fastener receipt slots 772, 774, 776, and 778 configured to receive and mate with these bolts.

Alternatively, the rewinder holder 770 includes a plurality and specifically four rewinder fastener securer receipt slots (not shown) extending inwardly from the bottom surface of the support 720 and respectively aligned with rewinder fastener securer receipt slots 772, 774, 776, and 778 and sized, shaped, and otherwise configured to respectively receive fastener engagers (such as washers and nuts (not shown)) that are connected to the fasteners extending downwardly in the rewinder fastener securer receipt slots 772, 774, 776, and 778 to securely attach the rewinder 500 to the support 720.

In this example embodiment, the printer holder 740 and the rewinder holder 770 are transversely offset along the longitudinal length of the top surface 724 of the support 720 such that the storage spool 600 is directly aligned with the paper exiting the draw lottery ticket printer 400. In this example embodiment, the rewinder fastener securer receipt slots 772, 774, 776, and 778 are thus offset with respect to the printer feet receipt slots 742, 744, 746, and 748.

When the rewinder 500 is positioned on the support 720 and attached by fasteners, the support 720 securely holds the rewinder 500 and prevents longitudinal and transverse movement of the rewinder 500 relative to the support 720 and to the printer 400 (that could occur, for instance, due to vibrations from the winding of the tickets by the rewinder 500).

The printer and rewinder cradle 700 of this example embodiment of the present disclosure thus enable the draw lottery ticket printer 400 to be positioned on the support 720 and to be engaged by the printer holder 740 such that it is in the precise desired position on the support 720 and does not move during operation of the draw lottery ticket printer 400.

The printer and rewinder cradle 700 of this example embodiment of the present disclosure also thus enable the rewinder 500 to be positioned on the support 720 and to be engaged by the rewinder holder 770 such that it is in the precise desired position on the support 720 and does not move during operation of the rewinder 500.

The printer and rewinder cradle 700 of this example embodiment of the present disclosure also enables the rewinder 500 to be positioned on the support 720 an exact desired distance from the draw lottery ticket printer 400 positioned on the support 720.

The printer and rewinder cradle 700 of this example embodiment of the present disclosure also enables the rewinder 500 to be positioned on the support 720 in an exact alignment with the draw lottery ticket printer 400 positioned on the support 720.

The precise distance between and precise alignment of the rewinder 500 and the draw lottery ticket printer 400 on the support 720 of the cradle 700 is important for the operation of the rewinder 500 and the draw lottery ticket printer 400 due to the nature of the printing of the draw lottery tickets by the draw lottery ticket printer 400. In particular, in various instances, the draw lottery ticket printer 400 can: (1) continuously print draw lottery tickets 406 on the elongated sheet from the supply roll 400; (2) print and stop printing draw lottery tickets 406 on the elongated sheet from the supply roll 400 on a regular basis; and (3) print and stop printing draw lottery tickets 406 on the elongated sheet from the supply roll 400 on an irregular basis.

In this example embodiment of the printer and rewinder cradle 700, there are no devices between the draw lottery ticket printer 400 and the rewinder 500.

In other embodiments of the present disclosure, one or more other devices can be positioned between the printer and the rewinder on or above the cradle. In such embodiments, such devices can include a scanner (not shown) and one or more paper engagers (not shown). In such embodiments, the longitudinal length of the support of the cradle can be increased such and the printer holder and rewinder holder can be spaced-apart a greater distance to provide room for such devices. In such embodiments, the cradle 700 can also include holders of those additional devices between the printer 400 and rewinder 600.

In alternative example embodiments, the rewinder 500 includes feet and the rewinder fastener receipt slots 772, 774, 776, and 778 are alternatively formed as rewinder feet receipt slots.

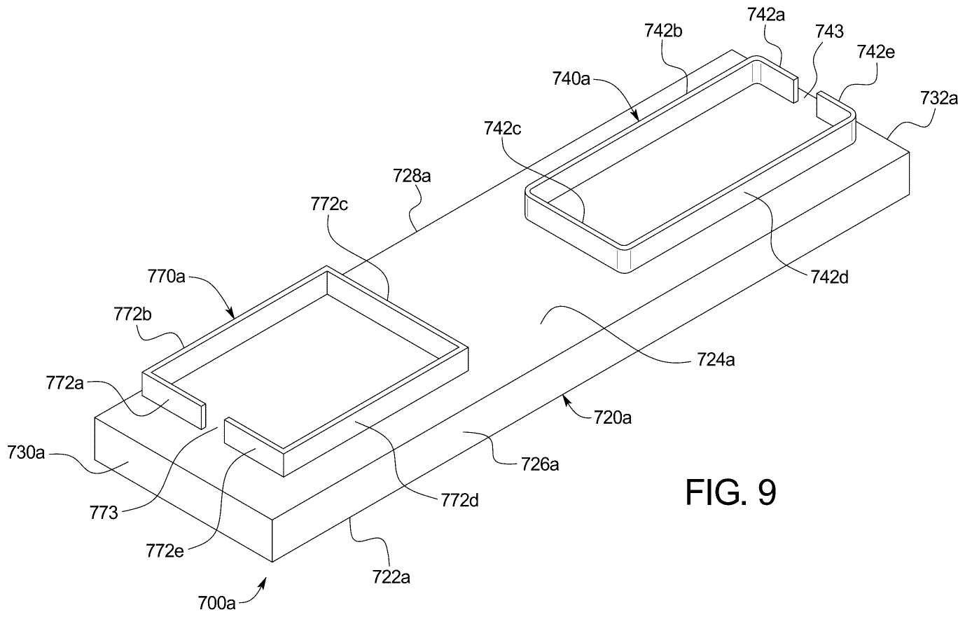

Turning now to FIG. 9, a printer and rewinder cradle 700a of another example embodiment of the present disclosure is shown and generally includes: (a) a support 720a; (b) a printer holder 740a; (c) a rewinder holder 770a.

The support 720a provides a support member for the printer 400 and the rewinder 500. In this example, the support 720a includes: (1) a bottom surface 722a; (2) a top surface 724a spaced-apart from the bottom surface 722a; (3) a first side surface 726a; (4) a second side surface 728a; (5) a first end surface 730a; and (6) a second end surface 732a. In this example embodiment, the support 720a is generally rectangular, but can be another suitable shape.

The printer holder 740a includes a plurality of upwardly extending printer engagers such as engager walls 742a, 742b, 742c, 742d, and 742e that extend upwardly from the top surface 724a of the support 720a and that are aligned, positioned, sized, shaped, and otherwise configured to respectively engage the four outer walls of the printer 400. These printer engagers maintain the printer in the desired position during operation of the printer 400. These printer engagers also define an opening 743 for electric cords (not shown) connected to the printer. It should be appreciated that these printer engagers and the opening can be alternatively shaped, sized, and otherwise configured.

The rewinder holder 770a includes a plurality of upwardly extending rewinder engagers such as engager walls 772a, 772b, 772c, 772d, and 772e that extend upwardly from the top surface 724a of the support 720a and that are aligned, positioned, sized, shaped, and otherwise configured to respectively engage the four outer edges of the based of the rewinder 500. These rewinder engagers maintain the rewinder in the desired position during operation of the rewinder. These rewinder engagers also define an opening 743 for electric cords (not shown) connected to the rewinder. It should be appreciated that these rewinder engagers and the opening can be alternatively shaped, sized, and otherwise configured.

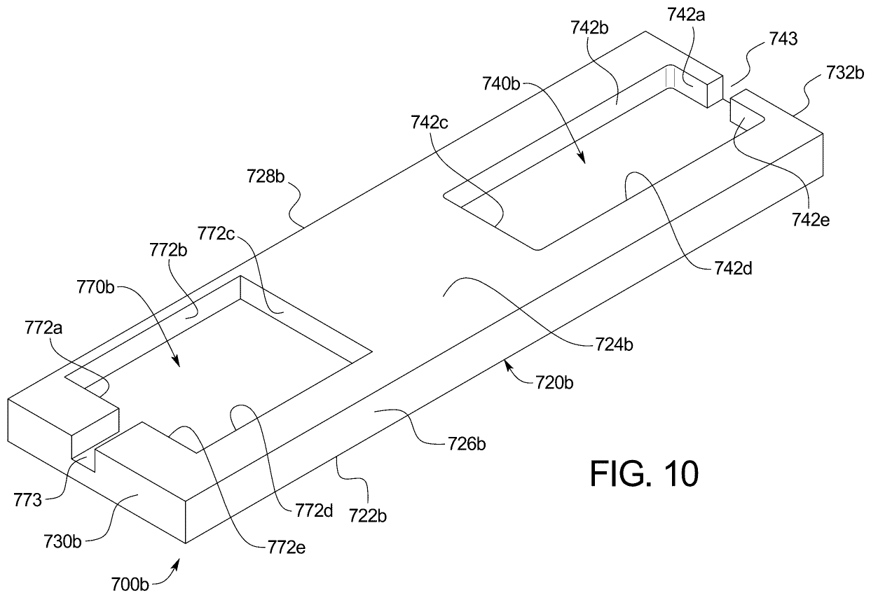

Turning now to FIG. 10, a printer and rewinder cradle 700b of another example embodiment of the present disclosure is shown and generally includes: (a) a support 720b; (b) a printer holder 740b; (c) a rewinder holder 770b.

The support 720b provides a support member for the printer 400 and the rewinder 500. In this example, the support 720b includes: (1) a bottom surface 722b; (2) a top surface 724b spaced-apart from the bottom surface 722b; (3) a first side surface 726b; (4) a second side surface 728b; (5) a first end surface 730b; and (6) a second end surface 732b. In this example embodiment, the support 720b is generally rectangular, but can be another suitable shape.

The printer holder 740b includes a plurality of downwardly extending printer engagers such as the printer engagement walls 742a, 742b, 742c, 742d, and 742e that extend downwardly from the top surface 724b of the support 720b and that are aligned, positioned, sized, shaped, and otherwise configured to respectively engage the outer four walls of the housing 410 of the printer 400. These printer engagers maintain the printer in the desired position during operation of the printer 400. These printer engagers also define an opening 743 for electric cords (not shown) connected to the printer. It should be appreciated that these printer engagers and the opening can be alternatively shaped, sized, and otherwise configured.

The rewinder holder 770b includes a plurality of rewinder engagers 772a, 772b, 772c, 772d, and 772e that extend downwardly from the top surface 724b of the support 720b and that are aligned, positioned, sized, shaped, and otherwise configured to respectively receive the four sides of the base 510 of the rewinder 500. These rewinder engagers maintain the rewinder 500 in the desired position during operation of the rewinder. These rewinder engagers also define an opening 743 for electric cords (not shown) connected to the rewinder 500. It should be appreciated that these rewinder engagers and the opening can be alternatively shaped, sized, and otherwise configured.

In various embodiments, two or more of the printer holders 740, 740a, and 740b can be employed together.

In various embodiments, two or more of the rewinder holder 770, 770a, and 770b can be employed together.

In various embodiments, combinations of one or more of the printer holders 740, 740a, and 740b and one or more of the rewinder holder 770, 770a, and 770b can be employed together.

In various embodiments, the draw lottery ticket rewinder 500 includes one or more sensors that detect when the continuous sheet of draw lottery tickets becomes loose such as being lower than a predetermined tension. When that happens, the draw lottery ticket rewinder 500 starts pulling on the continuous sheet of draw lottery tickets to roll it onto the storage spindle 600, or can increase the rate at which the draw lottery ticket rewinder 500 pull on the continuous sheet of draw lottery tickets to roll it onto the storage spool 600 at an increased rate.

In various other embodiments of the present disclosure, a processor of the electronic ticket courier server, a processor of the wager details display device, a processor of the lottery terminal, a processor of the lottery printer, a processor of the rewinder, another suitable processor, or suitable combinations thereof can control the rate of the rewinding of the continuous strip of printed draw lottery tickets 406 by the rewinder 500 based on the rate of the printing of the draw lottery tickets by the draw lottery ticket printer 400 and the predetermined static distance between such components provided by the cradle 700. In various such embodiments of the present disclosure where two processors such as the processor of the lottery printer and processor of the rewinder control the rewinding, such processors will be in suitable communication with each other. In various embodiments, such a processor can start the rewinding when or shortly after the draw lottery ticket printer 400 starts printing draw lottery tickets. In various embodiments, such a processor can stop the rewinding when the draw lottery ticket printer 400 stops or pauses printing draw lottery tickets or shortly thereafter. In various embodiments, such a processor can change the rate of the rewinding when the draw lottery ticket printer 400 based on a determined amount of tension on the continuous sheet of draw lottery tickets 406 based on data received by the printer from another component or from one of its sensors.

It should be appreciated from the above that various embodiments of the present disclosure provide a lottery ticket selling system comprising: (1) an electronic ticket courier server; (2) a wager details display device; (3) a lottery terminal; (4) a lottery ticket printer; (5) a draw lottery ticket printer; (6) a draw lottery ticket rewinder; and (7) a printer and rewinder cradle comprising a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support. In various such embodiments, the static distance enables the draw lottery ticket rewinder to apply a predetermined amount of tension to a continuous sheet of connected draw lottery tickets printed by the draw lottery ticket printer. In various such embodiments, the draw lottery ticket rewinder rotatably supports a removable storage spool for the continuous sheet of connected draw lottery tickets printed by the draw lottery ticket printer. In various such embodiments, the draw lottery ticket printer comprises a printer housing, a supply paper roll holder supported by the printer housing, a plurality of spaced-apart feet extending downwardly from the printer housing. In various such embodiments, printer holder of the printer and rewinder cradle defines a plurality of slots positioned and sized to receive the plurality of spaced-apart feet extending downwardly from the printer housing of the draw lottery ticket printer. In various such embodiments, the draw lottery ticket rewinder comprises a base, a support connected to and extending upwardly from the base, a drive motor supported by the support, a rotatable spool holder connected to and supported by the drive motor, wherein the spool holder is positioned to support a removable storage spool, wherein the base defines a plurality of spaced-apart fastener openings though which fasteners can extend to attach the draw lottery ticket rewinder to the printer and rewinder cradle. In various such embodiments, the rewinder holder of the printer and rewinder cradle defines a plurality of openings positioned and sized to receive the plurality of fasteners. In various such embodiments, the printer holder and the rewinder holder are transversely offset on the support. In various such embodiments, the printer feet receipt slots defined by the printer holder are transversely offset relative to the support from the rewinder fastener securer receipt slots of the rewinder holder. In various such embodiments, the printer holder comprises a plurality of upwardly extending printer engagers that extend upwardly from a top surface of the support. In various such embodiments, the rewinder holder comprises a plurality of upwardly extending rewinder engagers that extend upwardly from a top surface of the support. In various such embodiments, the printer holder comprises a plurality of downwardly extending printer engagers that extend downwardly from a top surface of the support. In various such embodiments, the rewinder holder comprises a plurality of rewinder engagers that extend downwardly from a top surface of the support.

It should further be appreciated from the above that various embodiments of the present disclosure provide a lottery ticket selling system comprising: (1) an electronic ticket courier server; (2) a wager details display device; (3) a lottery terminal; (4) a lottery ticket printer; (5) a draw lottery ticket printer; (6) a draw lottery ticket rewinder; and (7) a printer and rewinder cradle comprising a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support, wherein the static distance enables the draw lottery ticket rewinder to apply a predetermined amount of tension to a continuous sheet of connected draw lottery tickets printed by the draw lottery ticket printer, wherein the rewinder holder is positioned to hold the draw lottery ticket rewinder such that the draw lottery ticket rewinder can rotatably support a removable storage spool in alignment with a continuous sheet of connected draw lottery tickets printed by the draw lottery ticket printer. In various such embodiments, the printer holder and the rewinder holder are transversely offset on the support. In various such embodiments, the printer holder of the printer and rewinder cradle defines a plurality of slots positioned and sized to receive a plurality of spaced-apart feet extending downwardly from a printer housing of the draw lottery ticket printer, and the rewinder holder of the printer holder of the printer and rewinder cradle defines a plurality of slots positioned and sized to receive a plurality of spaced-fasteners that connect the draw lottery ticket rewinder to the printer and rewinder cradle.

It should further be appreciated from the above that various embodiments of the present disclosure provide a lottery ticket selling system comprising: (1) an electronic ticket courier server; (2) a wager details display device; (3) a lottery terminal; (4) a lottery ticket printer; (5) a draw lottery ticket printer; (6) a draw lottery ticket rewinder; (7) a printer and rewinder cradle comprising a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support, wherein the static distance enables the draw lottery ticket rewinder to apply a predetermined amount of tension to a continuous sheet of connected draw lottery tickets printed by the draw lottery ticket printer, wherein the rewinder holder is positioned to hold the draw lottery ticket rewinder such that the draw lottery ticket rewinder can rotatably support a removable storage spool in alignment with a continuous sheet of connected draw lottery tickets printed by the draw lottery ticket printer; and (8) a sensor that enables control of when the draw lottery ticket rewinder rewinds the continuous sheet of connected draw lottery tickets printed by the draw lottery ticket onto the storage spool. In various such embodiments, the lottery ticket selling system comprises a processor and a memory device that stores a plurality of instructions that, when executed by the processor, control the draw lottery ticket rewinder rewinding of the continuous sheet of connected draw lottery tickets printed by the draw lottery ticket on the storage spool. In various such embodiments, the plurality of instructions, when executed by the processor, cause the processor to cause the draw lottery ticket rewinder to start the rewinding of the draw lottery tickets after the draw lottery ticket printer starts printing the draw lottery tickets. In various such embodiments, the plurality of instructions, when executed by the processor, cause the processor to cause the draw lottery ticket rewinder to stop the rewinding of the draw lottery tickets after the draw lottery ticket printer stops printing the draw lottery tickets.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A lottery ticket selling system comprising:
an electronic ticket courier server;
a wager details display device;
a lottery terminal;
a lottery ticket printer;
a draw lottery ticket printer;
a draw lottery ticket rewinder; and
a printer and rewinder cradle comprising a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support.

2. The lottery ticket selling system of claim 1, wherein the static distance enables the draw lottery ticket rewinder to apply a predetermined amount of tension to a continuous sheet of connected draw lottery tickets printed by the draw lottery ticket printer.

3. The lottery ticket selling system of claim 1, wherein the draw lottery ticket rewinder rotatably supports a removable storage spool for the continuous sheet of connected draw lottery tickets printed by the draw lottery ticket printer.

4. The lottery ticket selling system of claim 1, wherein the draw lottery ticket printer comprises a printer housing, a supply paper roll holder supported by the printer housing, a plurality of spaced-apart feet extending downwardly from the printer housing.

5. The lottery ticket selling system of claim 4, wherein the printer holder of the printer and rewinder cradle defines a plurality of slots positioned and sized to receive the plurality of spaced-apart feet extending downwardly from the printer housing of the draw lottery ticket printer.

6. The lottery ticket selling system of claim 1, wherein the draw lottery ticket rewinder comprises a base, a support connected to and extending upwardly from the base, a drive motor supported by the support, a rotatable spool holder connected to and supported by the drive motor, wherein the spool holder is positioned to support a removable storage spool, wherein the base defines a plurality of spaced-apart fastener openings though which fasteners can extend to attach the draw lottery ticket rewinder to the printer and rewinder cradle.

7. The lottery ticket selling system of claim 1, wherein the rewinder holder of the printer and rewinder cradle defines a plurality of openings positioned and sized to receive the plurality of fasteners.

8. The lottery ticket selling system of claim 1, wherein the printer holder and the rewinder holder are transversely offset on the support.

9. The lottery ticket selling system of claim 1, wherein the printer feet receipt slots defined by the printer holder are transversely offset relative to the support from the rewinder fastener securer receipt slots of the rewinder holder.

10. The lottery ticket selling system of claim 1, wherein the printer holder comprises a plurality of upwardly extending printer engagers that extend upwardly from a top surface of the support.

11. The lottery ticket selling system of claim 1, wherein the rewinder holder comprises a plurality of upwardly extending rewinder engagers that extend upwardly from a top surface of the support.

12. The lottery ticket selling system of claim 1, wherein the printer holder comprises a plurality of downwardly extending printer engagers that extend downwardly from a top surface of the support.

13. The lottery ticket selling system of claim 1, wherein the rewinder holder comprises a plurality of rewinder engagers that extend downwardly from a top surface of the support.

14. A lottery ticket selling system comprising:
an electronic ticket courier server;
a wager details display device;
a lottery terminal;
a lottery ticket printer;
a draw lottery ticket printer;
a draw lottery ticket rewinder; and
a printer and rewinder cradle comprising a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support, wherein the static distance enables the draw lottery ticket rewinder to apply a predetermined amount of tension to a continuous sheet of connected draw lottery tickets printed by the draw lottery ticket printer, wherein the rewinder holder is positioned to hold the draw lottery ticket rewinder such that the draw lottery ticket rewinder can rotatably support a removable storage spool in alignment with a continuous sheet of connected draw lottery tickets printed by the draw lottery ticket printer.

15. The lottery ticket selling system of claim 14, wherein the printer holder and the rewinder holder are transversely offset on the support.

16. The lottery ticket selling system of claim 14, wherein the printer holder of the printer and rewinder cradle defines a plurality of slots positioned and sized to receive a plurality of spaced-apart feet extending downwardly from a printer housing of the draw lottery ticket printer, and the rewinder holder of the printer holder of the printer and rewinder cradle defines a plurality of slots positioned and sized to receive a plurality of spaced-fasteners that connect the draw lottery ticket rewinder to the printer and rewinder cradle.

17. A lottery ticket selling system comprising:
an electronic ticket courier server;
a wager details display device;
a lottery terminal;
a lottery ticket printer;
a draw lottery ticket printer;
a draw lottery ticket rewinder;
a printer and rewinder cradle comprising a support, a printer holder formed on the support, and a rewinder holder formed on the support at a static distance from the printer holder to enable precise positioning of the draw lottery ticket printer and the draw lottery ticket rewinder relative to each other on the support and to prevent longitudinal and transverse movement of the draw lottery ticket rewinder relative to the support and of the draw lottery ticket printer relative to the support, wherein the static distance enables the draw lottery ticket rewinder to apply a predetermined amount of tension to a continuous sheet of connected draw lottery tickets printed by the draw lottery ticket printer, wherein the rewinder holder is positioned to hold the draw lottery ticket rewinder such that the draw lottery ticket rewinder can rotatably support a removable storage spool in alignment with a continuous sheet of connected draw lottery tickets printed by the draw lottery ticket printer; and
a sensor that enables control of when the draw lottery ticket rewinder rewinds the continuous sheet of connected draw lottery tickets printed by the draw lottery ticket onto the storage spool.

18. The lottery ticket selling system of claim 17, which comprises a processor and a memory device that stores a plurality of instructions that, when executed by the processor, control the draw lottery ticket rewinder rewinding of the continuous sheet of connected draw lottery tickets printed by the draw lottery ticket on the storage spool.

19. The lottery ticket selling system of claim 18, wherein the plurality of instructions, when executed by the processor, cause the processor to cause the draw lottery ticket rewinder to start the rewinding of the draw lottery tickets after the draw lottery ticket printer starts printing the draw lottery tickets.

20. The lottery ticket selling system of claim 19, wherein the plurality of instructions, when executed by the processor, cause the processor to cause the draw lottery ticket rewinder to stop the rewinding of the draw lottery tickets after the draw lottery ticket printer stops printing the draw lottery tickets.
